(19) United States
(12) Patent Application Publication
(10) Pub. No.: US 2016/0373229 A1
(43) Pub. Date: Dec. 22, 2016

(54) Operational Method for MTC Device

(71) Applicant: LG Electronics Inc., Seoul (KR)

(72) Inventors: Hyangsun You, Seoul (KR); Yunjung Yi, Seoul (KR); Kijun Kim, Seoul (KR)

(73) Assignee: LG Electronics Inc., Seoul (KR)

(21) Appl. No.: 14/901,294

(22) PCT Filed: Jun. 20, 2014
(86) PCT No.: PCT/KR2014/005481

§ 371 Date: Dec. 28, 2015

Related U.S. Application Data
(60) Provisional application No. 61/839,831, filed on Jun. 26, 2013.

(51) Int. Cl. H04L 5/00; H04L 1/00; H04W 4/00

(52) U.S. Cl. CPC H04L 5/0057; H04W 4/005; H04L 1/0026; H04W 72/0453

(57) ABSTRACT

Provided is an operational method for a machine-type communication (MTC) device. The operational method may comprise the steps of: if a bandwidth of a data channel has a reduced size in comparison to a bandwidth of a cell system, then determining the size of a precoding resource block group (PRG) with respect to the reduced bandwidth size of the data channel, instead of the bandwidth size of the system; and, if a bandwidth of a data channel has a reduced size in comparison to a bandwidth of a cell system, then determining the size of a sub-band for a channel quality indicator (CQI) feedback with respect to the reduced bandwidth size of the data channel, instead of the bandwidth size of the system.

### BACKGROUND OF THE INVENTION

Field of the Invention

The present invention relates to mobile communication.

Related Art

3GPP (3rd Generation Partnership Project) LTE (Long Term Evolution) that is an advancement of UMTS (Universal Mobile Telecommunication System) is being introduced with 3GPP release 8. In 3GPP LTE, OFDMA (orthogonal frequency division multiple access) is used for downlink, and SC-FDMA (single carrier-frequency division multiple access) is used for uplink. The 3GPP LTE adopts MIMO (multiple input multiple output) having maximum four antennas. Recently, a discussion of 3GPP LTE-A (LTE-Advanced) which is the evolution of the 3GPP LTE is in progress.

As set forth in 3GPP TS 36.211 V10.4.0, the physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

Meanwhile, in recent years, communication, i.e., machine type communication (MTC), occurring between devices or between a device and a server without a human interaction, i.e., a human intervention, is actively under research. The MTC refers to the concept of communication based on an existing wireless communication network used by a machine device instead of a user equipment (UE) used by a user.

Since the MTC has a feature different from that of a normal UE, a service optimized to the MTC may differ from a service optimized to human-to-human communication. In comparison to a current mobile network communication service, the MTC can be characterized as a different market scenario, data communication, less costs and efforts, a potentially great number of MTC devices, wide service areas, low traffic for each MTC device, etc.

However, the MTC device must be able to be manufactured with a low unit cost to achieve a high distribution rate. As one method of decreasing a manufacturing unit cost, communication performance of the MTC device may be decreased to be lower than that required in LTE/LTE-A. As one exemplary method for decreasing the communication performance, a bandwidth may be reduced to be lower than that supported by the normal UE for LTE/LTE-A.

However, transmission/reception based on LTE/LTE-A may not be smoothly performed if the bandwidth is reduced as described above.

### SUMMARY OF THE INVENTION

Accordingly, the disclosure of the specification has been made in an effort to solve the problem.

In order to achieve the aforementioned purpose, the present specification provides an operational method in a machine type communication (MTC) device, comprising: if a bandwidth of a data channel has a reduced size in comparison to a system bandwidth of a cell, determining a size of a precoding resource block group (PRG) on the basis of the reduced bandwidth size of the data channel, instead of the size of the system bandwidth; and if the bandwidth of the data channel has the reduced size in comparison to the system bandwidth of the cell, determining a size of a subband for a channel quality indicator (CQI) feedback on the basis of the reduced bandwidth size of the data channel, instead of the size of the system bandwidth.

The size of the PRG is determined to 1, irrespective of the size of the system bandwidth.

All physical resource blocks (PRBs) in which the data channel is received are applied with the same precoding matrix.

The size of the subband is determined to 6 resource blocks (RBs), irrespective of the size of the system bandwidth.

The method may further comprise feeding back the CQI for the subband having the determined size.

The method may further comprise feeding back a CQI measurement result regarding an entirety of the reduced bandwidth of the data channel as a wideband CQI.

In order to achieve the aforementioned purpose, the present specification provides a machine type communication (MTC) device. The MTC device may comprise: a transceiver; and a processor for controlling the transceiver. If a bandwidth of a data channel has a reduced size in comparison to a system bandwidth of a cell, the processor determines a size of a precoding resource block group (PRG) on the basis of the reduced bandwidth size of the data channel, instead of the size of the system bandwidth. If the bandwidth of a data channel has the reduced size in comparison to the system bandwidth of the cell, the processor determines a size of a subband for a channel quality indicator (CQI) feedback on the basis of the reduced bandwidth size of the data channel, instead of the size of the system bandwidth.

According to the disclosure of the specification, the problem in the related art is solved.

### BRIEF DESCRIPTION OF THE DRAWINGS

FIG. 1 illustrates a wireless communication system.

FIG. 2 illustrates the architecture of a radio frame according to frequency division duplex (FDD) of 3rd generation partnership project (3GPP) long term evolution (LTE).

FIG. 3 illustrates the architecture of a downlink radio frame according to time division duplex (TDD) in 3GPP LTE.

FIG. 4 illustrates an example resource grid for one uplink or downlink slot in 3GPP LTE.

FIG. 5 illustrates the architecture of a downlink subframe.

FIG. 6 illustrates a subframe having an enhanced PDCCH (EPDCCH).

FIG. 7 illustrates the architecture of an uplink subframe in 3GPP LTE.

FIG. 8 illustrates an example of comparison between a single carrier system and a carrier aggregation system.

FIG. 9 exemplifies cross-carrier scheduling in a carrier aggregation system.

FIG. 10 shows an example of a pattern in which a cell-specific RS (CRS) is mapped to a resource block (RB) when a base station (BS) uses one antenna port.

FIG. 11 shows an example of a new carrier for a next-generation wireless communication system.

FIG. 12a illustrates an example of machine type communication (MTC).

FIG. 12b illustrates an example of cell coverage extension for an MTC device.

FIG. 13 shows an example in which a bandwidth of a data channel is reduced.

FIG. 14 shows an example of an unused resource element (RE) region.

FIG. 15 shows an example of an operating time distribution between an MTC device and a legacy normal user equipment (UE).

FIG. 16 is a block diagram illustrating a wireless communication system according to one disclosure of the present specification.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, user equipment (UE) may be stationary or mobile, and may be denoted by other terms such as device, wireless device, terminal, MS (mobile station), UT (user terminal), SS (subscriber station), MT (mobile terminal) and etc.

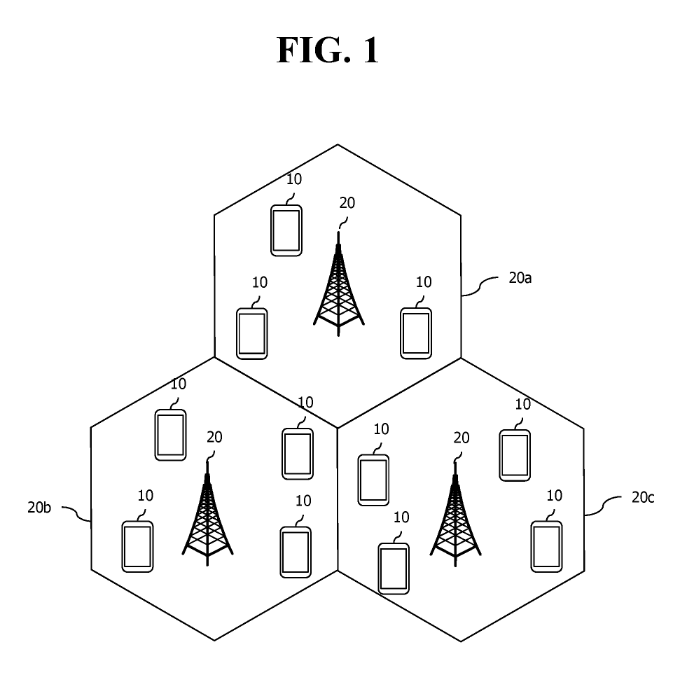

FIG. 1 Shows a Wireless Communication System.

Referring to FIG. 1, the wireless communication system includes at least one base station (BS) 20. Respective BSs 20 provide a communication service to particular geographical areas 20a, 20b, and 20c (which are generally called cells).

The UE generally belongs to one cell and the cell to which the terminal belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the terminal 10 and an uplink means communication from the terminal 10 to the base station 20. In the downlink, a transmitter may be a part of the base station 20 and a receiver may be a part of the terminal 10. In the uplink, the transmitter may be a part of the terminal 10 and the receiver may be a part of the base station 20.

Meanwhile, the wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmit antennas and a plurality of receive antennas. The MISO system uses a plurality of transmit antennas and one receive antenna. The SISO system uses one transmit antenna and one receive antenna. The SIMO system uses one transmit antenna and one receive antenna. Hereinafter, the transmit antenna means a physical or logical antenna used to transmit one signal or stream and the receive antenna means a physical or logical antenna used to receive one signal or stream.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

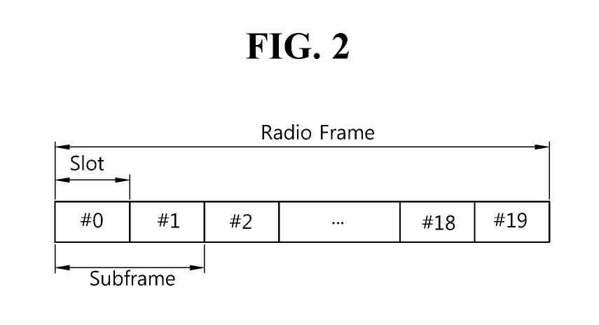

FIG. 2 Shows a Downlink Radio Frame Structure According to FDD of 3rd Generation Partnership Project (3GPP) Long Term Evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

Referring to FIG. 2, the radio frame consists of 10 subframes. One subframe consists of two slots. Slots included in the radio frame are numbered with slot numbers 0 to 19. A time required to transmit one subframe is defined as a transmission time interval (TTI). The TTI may be a scheduling unit for data transmission. For example, one radio frame may have a length of 10 milliseconds (ms), one subframe may have a length of 1 ms, and one slot may have a length of 0.5 ms.

The structure of the radio frame is for exemplary purposes only, and thus the number of subframes included in the radio frame or the number of slots included in the subframe may change variously.

Meanwhile, one slot may include a plurality of OFDM symbols. The number of OFDM symbols included in one slot may vary depending on a cyclic prefix (CP).

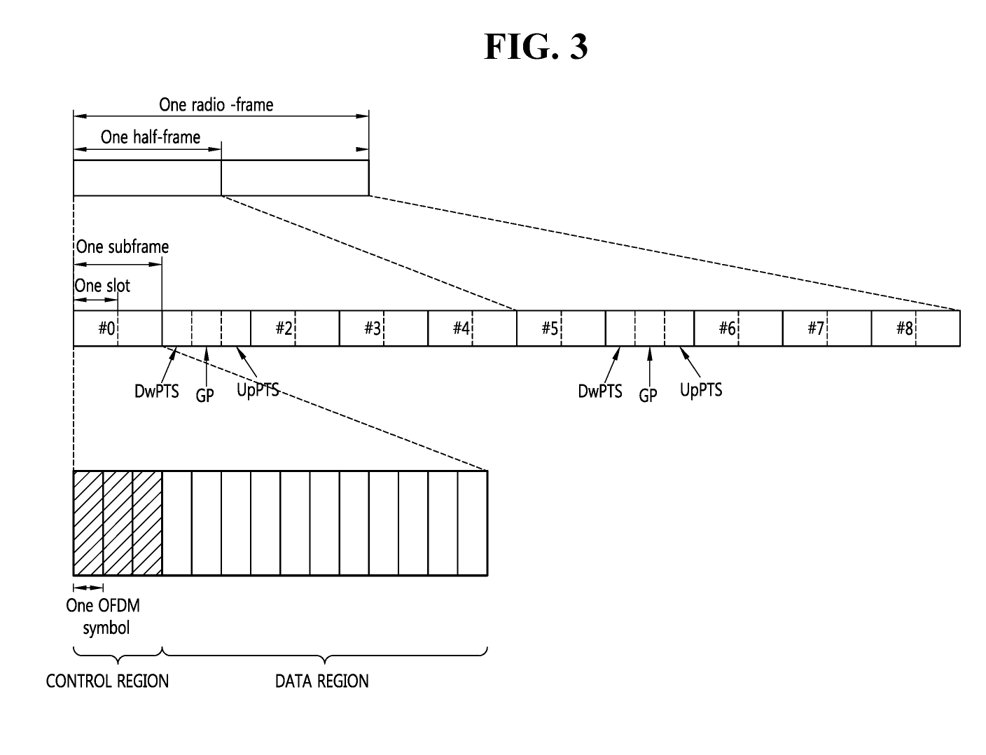

FIG. 3 Shows an Example of a Resource Grid for One Uplink or Downlink Slot in 3GPP LTE.

For this, 3GPP TS 36.211 V10.4.0 (2011-12) “Evolved Universal Terrestrial Radio Access (E-UTRA); Physical Channels and Modulation (Release 8)”, Ch. 4 may be referenced, and this is for TDD (time division duplex).

The radio frame includes 10 sub-frames indexed 0 to 9. One sub-frame includes two consecutive slots. The time for one sub-frame to be transmitted is denoted TTI (transmission time interval). For example, the length of one sub-frame may be 1 ms, and the length of one slot may be 0.5 ms.

One slot may include a plurality of OFDM (orthogonal frequency division multiplexing) symbols in the time domain. The OFDM symbol is merely to represent one symbol period in the time domain since 3GPP LTE adopts OFDMA (orthogonal frequency division multiple access) for downlink (DL), and thus, the multiple access scheme or name is not limited thereto. For example, OFDM symbol may be denoted by other terms such as SC-FDMA (single carrier-frequency division multiple access) symbol or symbol period.

By way of example, one slot includes seven OFDM symbols. However, the number of OFDM symbols included in one slot may vary depending on the length of CP (cyclic prefix). According to 3GPP TS 36.211 V8.7.0, one slot, in the normal CP, includes seven OFDM symbols, and in the extended CP, includes six OFDM symbols.

Resource block (RB) is a resource allocation unit and includes a plurality of sub-carriers in one slot. For example, if one slot includes seven OFDM symbols in the time domain and the resource block includes 12 sub-carriers in the frequency domain, one resource block may include 7×12 resource elements (REs).

Sub-frames having index #1 and index #6 are denoted special sub-frames, and include a DwPTS (Downlink Pilot Time Slot: DwPTS), a GP (Guard Period) and an UpPTS (Uplink Pilot Time Slot). The DwPTS is used for initial cell search, synchronization, or channel estimation in a terminal. The UpPTS is used for channel estimation in the base station and for establishing uplink transmission sync of the terminal. The GP is a period for removing interference that arises on uplink due to a multi-path delay of a downlink signal between uplink and downlink.

In TDD, a DL (downlink) sub-frame and a UL (Uplink) co-exist in one radio frame. Table 1 shows an example of configuration of a radio frame.

TABLE 1

| UL-DL | Switch- | | | | | | | | | | |
|---|---|---|---|---|---|---|---|---|---|---|---|
| Config- | point | Subframe index | | | | | | | | | |
| uraiton | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

‘D’ denotes a DL sub-frame, ‘U’ a UL sub-frame, and ‘S’ a special sub-frame. When receiving a UL-DL configuration from the base station, the terminal may be aware of whether a sub-frame is a DL sub-frame or a UL sub-frame according to the configuration of the radio frame.

The DL (downlink) sub-frame is split into a control region and a data region in the time domain. The control region includes up to three first OFDM symbols in the first slot of the sub-frame. However, the number of OFDM symbols included in the control region may be changed. A PDCCH and other control channels are assigned to the control region, and a PDSCH is assigned to the data region.

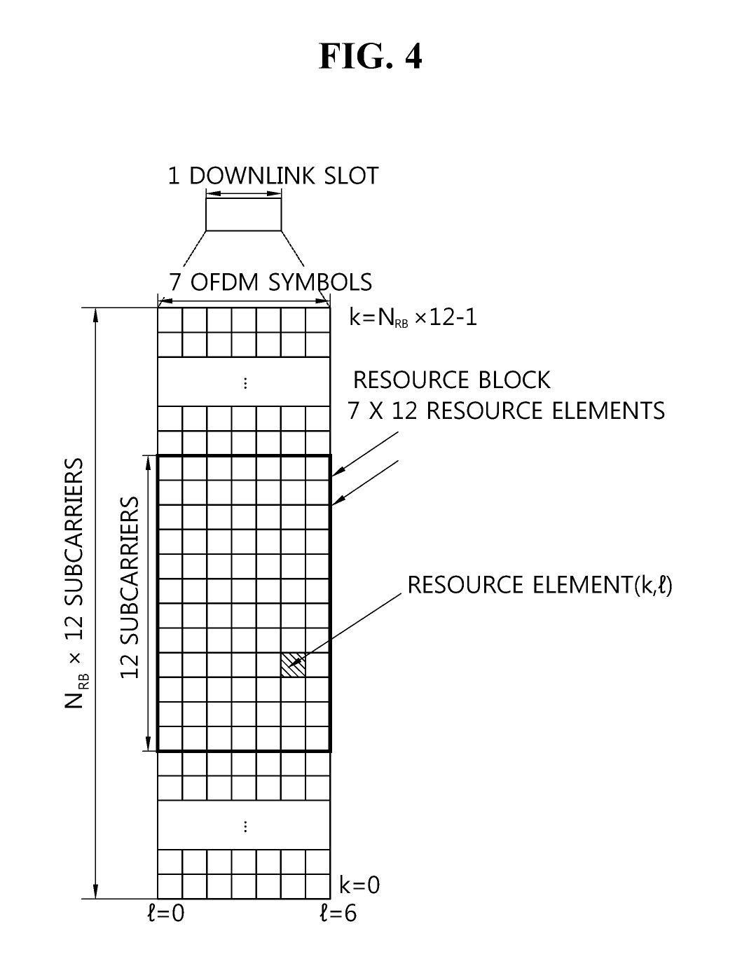

FIG. 4 Illustrates an Example Resource Grid for One Uplink or Downlink Slot in 3GPP LTE.

Referring to FIG. 4, the uplink slot includes a plurality of OFDM (orthogonal frequency division multiplexing) symbols in the time domain and N_{RB} resource blocks (RBs) in the frequency domain. For example, in the LTE system, the number of resource blocks (RBs), i.e., N_{RB}, may be one from 6 to 110.

Here, by way of example, one resource block includes 7×12 resource elements that consist of seven OFDM symbols in the time domain and 12 sub-carriers in the frequency domain. However, the number of sub-carriers in the resource block and the number of OFDM symbols are not limited thereto. The number of OFDM symbols in the resource block or the number of sub-carriers may be changed variously. In other words, the number of OFDM symbols may be varied depending on the above-described length of CP. In particular, 3GPP LTE defines one slot as having seven OFDM symbols in the case of CP and six OFDM symbols in the case of extended CP.

OFDM symbol is to represent one symbol period, and depending on system, may also be denoted SC-FDMA symbol, OFDM symbol, or symbol period. The resource block is a unit of resource allocation and includes a plurality of sub-carriers in the frequency domain. The number of resource blocks included in the uplink slot, i.e., N_{UL}, is dependent upon an uplink transmission bandwidth set in a cell. Each element on the resource grid is denoted resource element.

Meanwhile, the number of sub-carriers in one OFDM symbol may be one of 128, 256, 512, 1024, 1536, and 2048.

In 3GPP LTE, the resource grid for one uplink slot shown in FIG. 4 may also apply to the resource grid for the downlink slot.

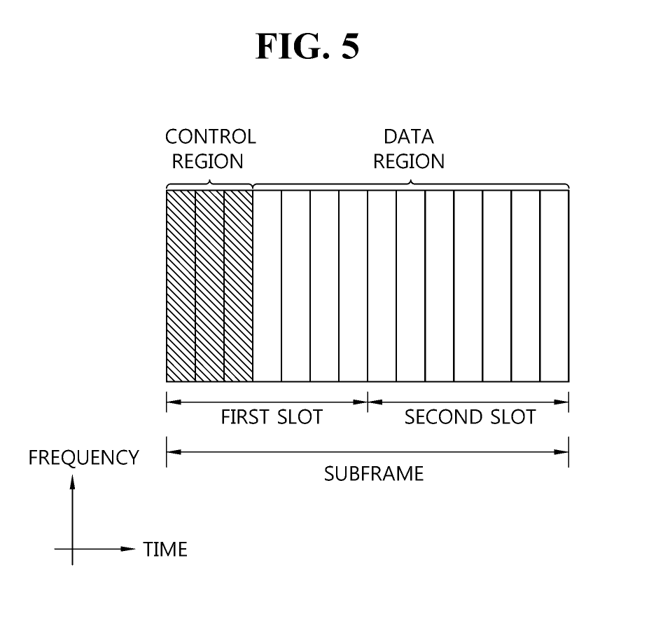

FIG. 5 Illustrates the Architecture of a Downlink Sub-Frame.

In FIG. 5, assuming the normal CP, one slot includes seven OFDM symbols, by way of example. However, the number of OFDM symbols included in one slot may vary depending on the length of CP (cyclic prefix). That is, as described above, according to 3GPP TS 36.211 V 10.4.0, one slot includes seven OFDM symbols in the normal CP and six OFDM symbols in the extended CP.

Resource block (RB) is a unit for resource allocation and includes a plurality of sub-carriers in one slot. For example, if one slot includes seven OFDM symbols in the time domain and the resource block includes 12 sub-carriers in the frequency domain, one resource block may include 7×12 resource elements (REs).

The DL (downlink) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are assigned to the control region, and a PDSCH is assigned to the data region.

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The PCFICH transmitted in the first OFDM symbol of the sub-frame carries CIF (control format indicator) regarding the number (i.e., size of the control region) of OFDM symbols used for transmission of control channels in the sub-frame. The wireless device first receives the CIF on the PCFICH and then monitors the PDCCH.

Unlike the PDCCH, the PCFICH is transmitted through a fixed PCFICH resource in the sub-frame without using blind decoding.

The PHICH carries an ACK (positive-acknowledgement)/NACK (negative-acknowledgement) signal for a UL HARQ (hybrid automatic repeat request). The ACK/NACK signal for UL (uplink) data on the PUSCH transmitted by the wireless device is sent on the PHICH.

The PBCH (physical broadcast channel) is transmitted in the first four OFDM symbols in the second slot of the first sub-frame of the radio frame. The PBCH carries system information necessary for the wireless device to communicate with the base station, and the system information transmitted through the PBCH is denoted MIB (master information block). In comparison, system information transmitted on the PDSCH indicated by the PDCCH is denoted SIB (system information block).

The PDCCH may carry activation of VoIP (voice over internet protocol) and a set of transmission power control commands for individual UEs in some UE group, resource allocation of an higher layer control message such as a random access response transmitted on the PDSCH, system information on DL-SCH, paging information on PCH, resource allocation information of UL-SCH (uplink shared channel), and resource allocation and transmission format of DL-SCH (downlink-shared channel). A plurality of PDCCHs may be sent in the control region, and the terminal may monitor the plurality of PDCCHs. The PDCCH is transmitted on one CCE (control channel element) or aggregation of some consecutive CCEs. The CCE is a logical allocation unit used for providing a coding rate per radio channel's state to the PDCCH. The CCE corresponds to a plurality of resource element groups. Depending on the relationship between the number of CCEs and coding rates provided by the CCEs, the format of the PDCCH and the possible number of PDCCHs are determined.

The control information transmitted through the PDCCH is denoted downlink control information (DCI). The DCI may include resource allocation of PDSCH (this is also referred to as DL (downlink) grant), resource allocation of PUSCH (this is also referred to as UL (uplink) grant), a set of transmission power control commands for individual UEs in some UE group, and/or activation of VoIP (Voice over Internet Protocol).

The base station determines a PDCCH format according to the DCI to be sent to the terminal and adds a CRC (cyclic redundancy check) to control information. The CRC is masked with a unique identifier (RNTI; radio network temporary identifier) depending on the owner or purpose of the PDCCH. In case the PDCCH is for a specific terminal, the terminal's unique identifier, such as C-RNTI (cell-RNTI), may be masked to the CRC. Or, if the PDCCH is for a paging message, a paging indicator, for example, P-RNTI (paging-RNTI) may be masked to the CRC. If the PDCCH is for a system information block (SIB), a system information identifier, SI-RNTI (system information-RNTI), may be masked to the CRC. In order to indicate a random access response that is a response to the terminal's transmission of a random access preamble, an RA-RNTI (random access-RNTI) may be masked to the CRC.

In 3GPP LTE, blind decoding is used for detecting a PDCCH. The blind decoding is a scheme of identifying whether a PDCCH is its own control channel by demasking a desired identifier to the CRC (cyclic redundancy check) of a received PDCCH (this is referred to as candidate PDCCH) and checking a CRC error. The base station determines a PDCCH format according to the DCI to be sent to the wireless device, then adds a CRC to the DCI, and masks a unique identifier (this is referred to as RNTI (radio network temporary identifier) to the CRC depending on the owner or purpose of the PDCCH.

A control region in a subframe includes a plurality of control channel elements (CCEs). The CCE is a logical allocation unit used to provide the PDCCH with a coding rate depending on a radio channel state, and corresponds to a plurality of resource element groups (REGs). The REG includes a plurality of resource elements. According to an association relation of the number of CCEs and the coding rate provided by the CCEs, a PDCCH format and the number of bits of an available PDCCH are determined.

One REG includes 4 REs. One CCE includes 9 REGs. The number of CCEs used to configure one PDCCH may be selected from a set {1, 2, 4, 8}. Each element of the set {1, 2, 4, 8} is referred to as a CCE aggregation level.

The BS determines the number of CCEs used in transmission of the PDCCH according to a channel state. For example, a wireless device having a good DL channel state can use one CCE in PDCCH transmission. A wireless device having a poor DL channel state can use 8 CCEs in PDCCH transmission.

A control channel consisting of one or more CCEs performs interleaving on an REG basis, and is mapped to a physical resource after performing cyclic shift based on a cell identifier (ID).

Meanwhile, a UE is unable to know that the PDCCH of its own is transmitted on which position within control region and using which CCE aggregation level or DCI format. Since a plurality of PDCCHs may be transmitted in one subframe, the UE monitors a plurality of PDCCHs in every subframe. Here, the monitoring is referred to try to decode the PDCCH by the UE according to the PDCCH format.

In 3GPP LTE, in order to decrease the load owing to the blind decoding, a search space is used. The search space may be referred to a monitoring set of CCE for the PDCCH. The UE monitors the PDCCH within the corresponding search space.

When a UE monitors the PDCCH based on the C-RNTI, the DCI format and the search space which is to be monitored are determined according to the transmission mode of the PDSCH. The table below represents an example of the PDCCH monitoring in which the C-RNTI is setup.

TABLE 2

| Transmission | | | Transmission mode of PDSCH according |
|---|---|---|---|
| mode | DCI format | Search space | to PDCCH |
| Mode 1 | DCI format 1A | Common and | Single antenna port, port 0 |
| | | UE-specific | |
| | DCI format 1 | UE-specific | Single antenna port, port 0 |
| Mode 2 | DCI format 1A | Common and | Transmission diversity |
| | | UE-specific | |
| | DCI format 1 | UE-specific | Transmission diversity |
| Mode 3 | DCI format 1A | Common and | Transmission diversity |
| | | UE-specific | |
| | DCI format 2A | UE-specific | CDD (Cyclic Delay Diversity) or |
| | | | Transmission diversity |
| Mode 4 | DCI format 1A | Common and | Transmission diversity |
| | | UE-specific | |
| | DCI format 2 | UE-specific | Closed-loop spatial multiplexing |
| Mode 5 | DCI format 1A | Common and | Transmission diversity |
| | | UE-specific | |
| | DCI format 1D | UE-specific | MU-MIMO (Multi-user Multiple Input |
| | | | Multiple Output) |
| Mode 6 | DCI format 1A | Common and | Transmission diversity |
| | | UE-specific | |
| | DCI format 1B | UE-specific | Closed-loop spatial multiplexing |
| Mode 7 | DCI format 1A | Common and | Single antenna port, port 0 if the number |
| | | UE-specific | of PBCH transmission port is 1, otherwise |
| | | | Transmission diversity |
| | DCI format 1 | UE-specific | Single antenna port, port 5 |
| Mode 8 | DCI format 1A | Common and | Single antenna port, port 0 if the number |
| | | UE-specific | of PBCH transmission port is 1, otherwise |
| | | | Transmission diversity |
| | DCI format 2B | UE-specific | Dual layer transmission (port 7 or 8), or |
| | | | single antenna port, port 7 or 8 |

A usage of the DCI format is classified as shown in the following table.

TABLE 3

| DCI format | Contents |
|---|---|
| DCI format 0 | Used for PUSCH scheduling |
| DCI format 1 | Used for scheduling one PDSCH codeword |
| DCI format 1A | Used for compact scheduling of one PDSCH codeword |
| | and random access procedure |
| DCI format 1B | Used for compact scheduling of one PDSCH codeword |
| | including precoding information |
| DCI format 1C | Used for very compact scheduling of one PDSCH |
| | codeword |
| DCI format 1D | Used for precoding and compact scheduling of one |
| | PDSCH codeword including power offset information |
| DCI format 2 | Used for PDSCH scheduling UEs setup as closed-loop |
| | spatial multiplexing |
| DCI format 2A | Used for PDSCH scheduling UEs setup as open-loop |
| | spatial multiplexing |
| DCI format 3 | Used for transmitting PUCCH having 2 bit power |
| | adjustments and TPC command of PUSCH |
| DCI format 3A | Used for transmitting PUCCH having 1 bit power |
| | adjustments and TPC command of PUSCH |

The uplink channels include a PUSCH, a PUCCH, an SRS (Sounding Reference Signal), and a PRACH (physical random access channel).

Meanwhile, the PDCCH is monitored in an area restricted to the control region in the subframe, and a CRS transmitted in a full band is used to demodulate the PDCCH. As a type of control data is diversified and an amount of control data is increased, scheduling flexibility is decreased when using only the existing PDCCH. In addition, in order to decrease an overhead caused by CRS transmission, an enhanced PDCCH (EPDCCH) is introduced.

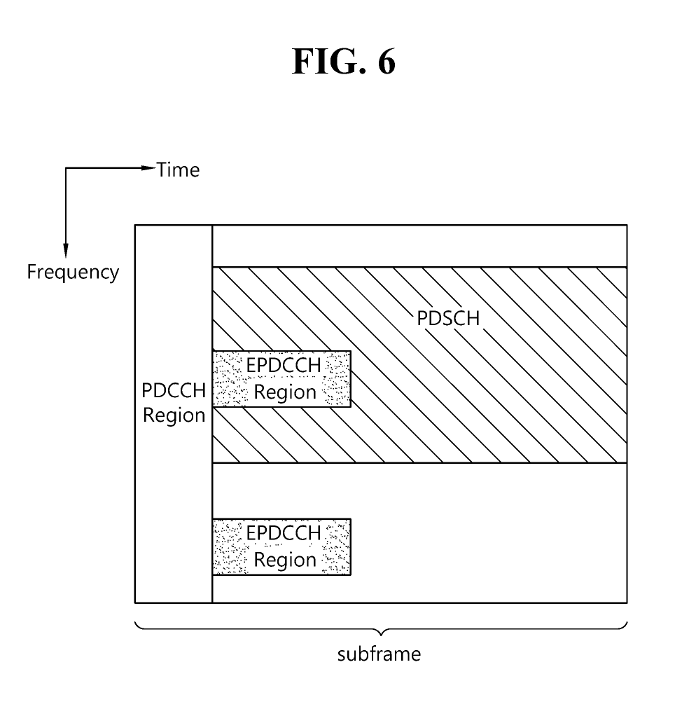

FIG. 6 illustrates a subframe having an EPDCCH.

A subframe may include a zero or one PDCCH region or zero or more EPDCCH regions.

The EPDCCH regions are regions in which a wireless device monitors an EPDCCH. The PDCCH region is located in up to four front OFDM symbols of a subframe, while the EPDCCH regions may flexibly be scheduled in OFDM symbols after the PDCCH region.

One or more EPDCCH regions may be designated for the wireless device, and the wireless devices may monitor an EPDCCH in the designated EPDCCH regions.

The number/location/size of the EPDCCH regions and/or information on a subframe for monitoring an EPDCCH may be provided by a base station to a wireless device through an RRC message or the like.

In the PDCCH region, a PDCCH may be demodulated based on a CRS. In the EPDCCH regions, a demodulation (DM) RS may be defined, instead of a CRS, for demodulation of an EPDCCH. An associated DM RS may be transmitted in the corresponding EPDCCH regions.

The respective EPDCCH regions may be used for scheduling of different cells. For example, an EPDCCH in the EPDCCH region may carry scheduling information for a primary cell, and an EPDCCH in the EPDCCH region may carry scheduling information for a secondary cell.

When an EPDCCH is transmitted through multiple antennas in the EPDCCH regions, the same precoding as that for the EPDCCH may be applied to a DM RS in the EPDCCH regions.

A PDCCH uses a CCE as a transmission resource unit, and a transmission resource unit for an EPDCCH is referred to as an enhanced control channel element (ECCE). An aggregation level may be defined as a resource unit for monitoring an EPDCCH. For example, when 1 ECCE is a minimum resource for an EPDCCH, an aggregation level may be defined as L={1, 2, 4, 8, 16}.

As illustrated, the EPDCCH is transmitted in the existing PDSCH region, and can acquire a beamforming gain and spatial diversity gain according to a transmission type. Further, since the EPDCCH transmits control information, higher reliability is required in comparison to data transmission, and to satisfy this, the concept of an aggregation level or the like is used to decrease a coding rate. The high aggregation level can decrease the coding rate, and thus can increase a demodulation accuracy, but has a disadvantage in that performance is decreased due to an increase in resources in use.

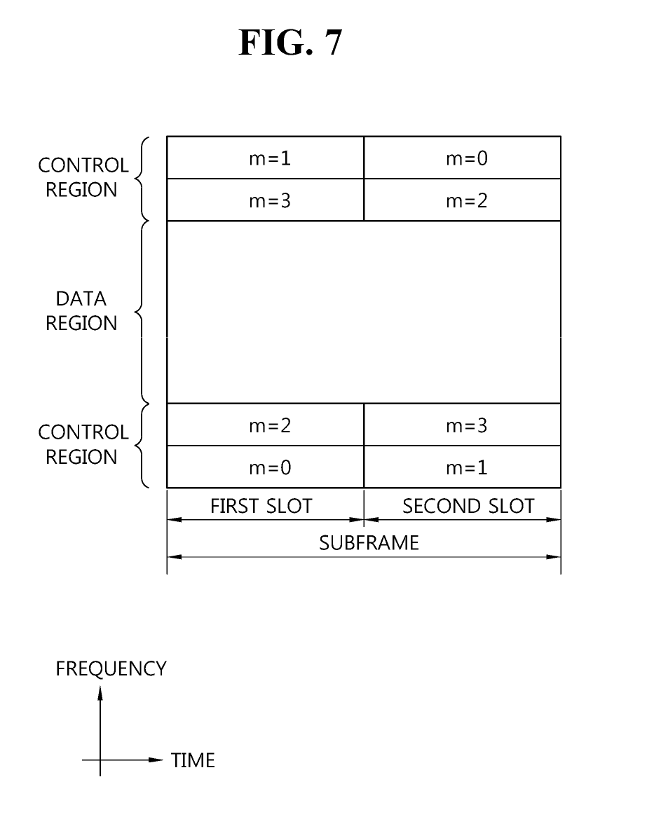

FIG. 7 Illustrates the Architecture of an Uplink Sub-Frame in 3GPP LTE.

Referring to FIG. 7, the uplink sub-frame may be separated into a control region and a data region in the frequency domain. The control region is assigned a PUCCH (physical uplink control channel) for transmission of uplink control information. The data region is assigned a PUSCH (physical uplink shared channel) for transmission of data (in some cases, control information may also be transmitted).

The PUCCH for one terminal is assigned in resource block (RB) pair in the sub-frame. The resource blocks in the resource block pair take up different sub-carriers in each of the first and second slots. The frequency occupied by the resource blocks in the resource block pair assigned to the PUCCH is varied with respect to a slot boundary. This is referred to as the RB pair assigned to the PUCCH having been frequency-hopped at the slot boundary.

The terminal may obtain a frequency diversity gain by transmitting uplink control information through different sub-carriers over time. m is a location index that indicates a logical frequency domain location of a resource block pair assigned to the PUCCH in the sub-frame.

The uplink control information transmitted on the PUCCH includes an HARQ (hybrid automatic repeat request), an ACK (acknowledgement)/NACK (non-acknowledgement), a CQI (channel quality indicator) indicating a downlink channel state, and an SR (scheduling request) that is an uplink radio resource allocation request.

The PUSCH is mapped with a UL-SCH that is a transport channel. The uplink data transmitted on the PUSCH may be a transport block that is a data block for the UL-SCH transmitted for the TTI. The transport block may be user information. Or, the uplink data may be multiplexed data. The multiplexed data may be data obtained by multiplexing the transport block for the UL-SCH and control information. For example, the control information multiplexed with the data may include a CQI, a PMI (precoding matrix indicator), an HARQ, and an RI (rank indicator). Or, the uplink data may consist only of control information.

A carrier aggregation system is now described.

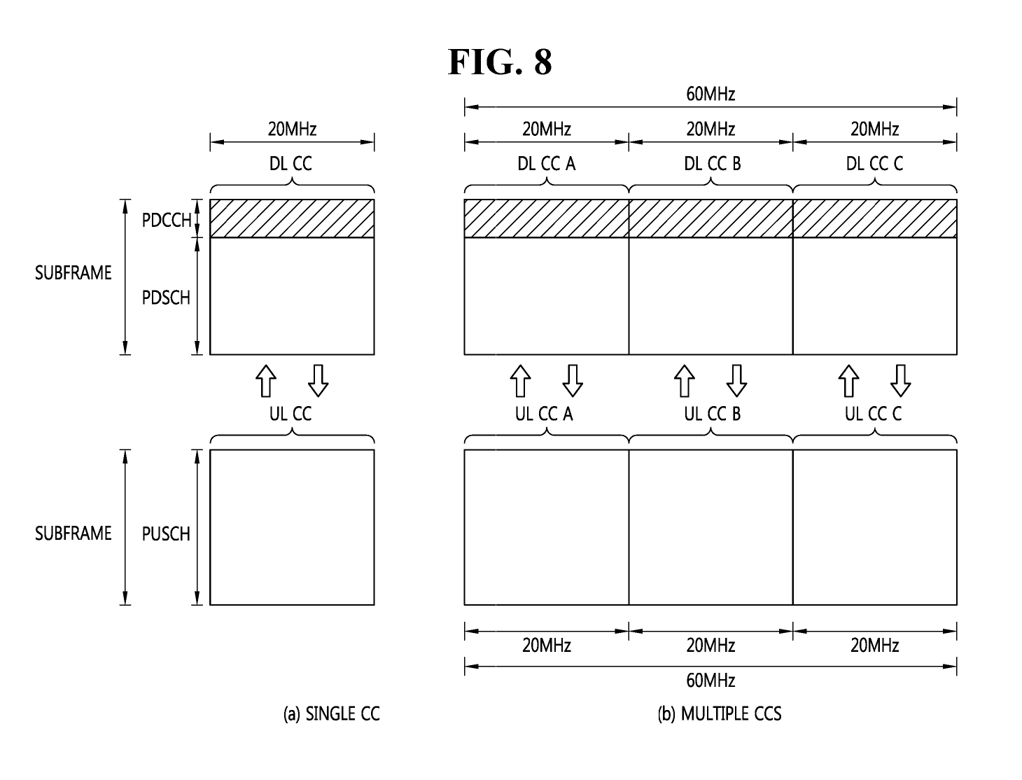

FIG. 8 Illustrates an Example of Comparison Between a Single Carrier System and a carrier aggregation system.

Referring to FIG. 8, there may be various carrier bandwidths, and one carrier is assigned to the terminal. On the contrary, in the carrier aggregation (CA) system, a plurality of component carriers (DL CC A to C, UL CC A to C) may be assigned to the terminal. Component carrier (CC) means the carrier used in then carrier aggregation system and may be briefly referred as carrier. For example, three 20 MHz component carriers may be assigned so as to allocate a 60 MHz bandwidth to the terminal.

Carrier aggregation systems may be classified into a contiguous carrier aggregation system in which aggregated carriers are contiguous and a non-contiguous carrier aggregation system in which aggregated carriers are spaced apart from each other. Hereinafter, when simply referring to a carrier aggregation system, it should be understood as including both the case where the component carrier is contiguous and the case where the control channel is non-contiguous.

When one or more component carriers are aggregated, the component carriers may use the bandwidth adopted in the existing system for backward compatibility with the existing system. For example, the 3GPP LTE system supports bandwidths of 1.4 MHz, 3 MHz, 5 MHz, 10 MHz, 15 MHz and 20 MHz, and the 3GPP LTE-A system may configure a broad band of 20 MHz or more only using the bandwidths of the 3GPP LTE system. Or, rather than using the bandwidths of the existing system, new bandwidths may be defined to configure a wide band.

The system frequency band of a wireless communication system is separated into a plurality of carrier frequencies. Here, the carrier frequency means the cell frequency of a cell. Hereinafter, the cell may mean a downlink frequency resource and an uplink frequency resource. Or, the cell may refer to a combination of a downlink frequency resource and an optional uplink frequency resource. Further, in the general case where carrier aggregation (CA) is not in consideration, one cell may always have a pair of an uplink frequency resource and a downlink frequency resource.

In order for packet data to be transmitted/received through a specific cell, the terminal should first complete a configuration on the specific cell. Here, the configuration means that reception of system information necessary for data transmission/reception on a cell is complete. For example, the configuration may include an overall process of receiving common physical layer parameters or MAC (media access control) layers necessary for data transmission and reception or parameters necessary for a specific operation in the RRC layer. A configuration-complete cell is in the state where, once when receiving information indicating packet data may be transmitted, packet transmission and reception may be immediately possible.

The cell that is in the configuration complete state may be left in an activation or deactivation state. Here, the “activation” means that data transmission or reception is being conducted or is in ready state. The terminal may monitor or receive a control channel (PDCCH) and a data channel (PDSCH) of the activated cell in order to identify resources (possibly frequency or time) assigned thereto.

The “deactivation” means that transmission or reception of traffic data is impossible while measurement or transmission/reception of minimal information is possible. The terminal may receive system information (SI) necessary for receiving packets from the deactivated cell. In contrast, the terminal does not monitor or receive a control channel (PDCCH) and data channel (PDSCH) of the deactivated cell in order to identify resources (probably frequency or time) assigned thereto.

Cells may be classified into primary cells and secondary cells, serving cells.

The primary cell means a cell operating at a primary frequency. The primary cell is a cell where the terminal conducts an initial connection establishment procedure or connection re-establishment procedure with the base station or is a cell designated as a primary cell during the course of handover.

The secondary cell means a cell operating at a secondary frequency. The secondary cell is configured once an RRC connection is established and is used to provide an additional radio resource.

The serving cell is configured as a primary cell in case no carrier aggregation is configured or when the terminal cannot offer carrier aggregation. In case carrier aggregation is configured, the term “serving cell” denotes a cell configured to the terminal and a plurality of serving cells may be included. One serving cell may consist of one downlink component carrier or a pair of {downlink component carrier, uplink component carrier}. A plurality of serving cells may consist of a primary cell and one or more of all the secondary cells.

As described above, the carrier aggregation system, unlike the single carrier system, may support a plurality of component carriers (CCs), i.e., a plurality of serving cells.

Such carrier aggregation system may support cross-carrier scheduling. The cross-carrier scheduling is a scheduling scheme that may conduct resource allocation of a PUSCH transmitted through other component carriers than the component carrier basically linked to a specific component carrier and/or resource allocation of a PDSCH transmitted through other component carriers through a PDCCH transmitted through the specific component carrier. In other words, the PDCCH and the PDSCH may be transmitted through different downlink CCs, and the PUSCH may be transmitted through an uplink CC other than the uplink CC linked to the downlink CC where the PDCCH including a UL grant is transmitted. As such, the system supporting cross-carrier scheduling needs a carrier indicator indicating a DL CC/UL CC through which a PDSCH/PUSCH is transmitted where the PDCCH offers control information. The field including such carrier indicator is hereinafter denoted carrier indication field (CIF).

The carrier aggregation system supporting cross-carrier scheduling may contain a carrier indication field (CIF) in the conventional DCI (downlink control information) format. In the cross-carrier scheduling-supportive carrier aggregation system, for example, an LTE-A system, may have 3 bits expanded due to addition of the CIF to the existing DCI format (i.e., the DCI format used in the LTE system), and the PDCCH architecture may reuse the existing coding method or resource allocation method (i.e., CCE-based resource mapping).

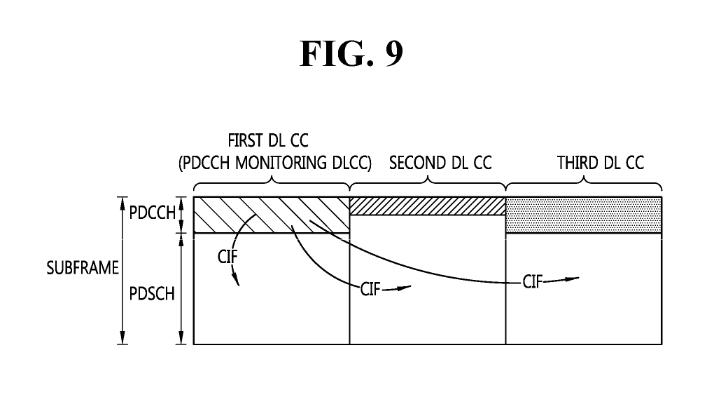

FIG. 9 Exemplifies Cross-Carrier Scheduling in the Carrier Aggregation System.

Referring to FIG. 9, the base station may configure a PDCCH monitoring DL CC (monitoring CC) set. The PDCCH monitoring DL CC set consists of some of all of the aggregated DL CCs, and if cross-carrier scheduling is configured, the user equipment performs PDCCH monitoring/decoding only on the DL CCs included in the PDCCH monitoring DL CC set. In other words, the base station transmits a PDCCH for PDSCH/PUSCH that is subject to scheduling only through the DL CCs included in the PDCCH monitoring DL CC set. The PDCCH monitoring DL CC set may be configured UE-specifically, UE group-specifically, or cell-specifically.

FIG. 9 illustrates an example in which three DL CCs (DL CC A, DL CC B, and DL CC C) are aggregated, and DL CC A is set as a PDCCH monitoring DL CC. The user equipment may receive a DL grant for the PDSCH of DL CC A, DL CC B, and DL CC C through the PDCCH of DL CC A. The DCI transmitted through the PDCCH of DL CC A contains a CIF so that it may indicate which DL CC the DCI is for.

Meanwhile, various reference signals (RSs) are transmitted in a subframe.

In general, a reference signal (RS) is transmitted as a sequence. Any sequence may be used as a sequence used for an RS sequence without particular restrictions. The RS sequence may be a phase shift keying (PSK)-based computer generated sequence. Examples of the PSK include binary phase shift keying (BPSK), quadrature phase shift keying (QPSK), etc. Alternatively, the RS sequence may be a constant amplitude zero auto-correlation (CAZAC) sequence. Examples of the CAZAC sequence include a Zadoff-Chu (ZC)-based sequence, a ZC sequence with cyclic extension, a ZC sequence with truncation, etc. Alternatively, the RS sequence may be a pseudo-random (PN) sequence. Examples of the PN sequence include an m-sequence, a computer generated sequence, a Gold sequence, a Kasami sequence, etc. In addition, the RS sequence may be a cyclically shifted sequence.

A downlink reference signal (RS) can be classified into a cell-specific RS (CRS), a Multimedia Broadcast and multicast Single Frequency Network (MBSFN) RS, a UE-specific RS (URS), a positioning RS (PRS), and a channel state information (CSI) RS (CSI-RS). The CRS is an RS transmitted to all UEs in a cell. The CRS can be used in channel measurement for a CQI feedback and in channel estimation for a PDSCH. The MBSFN RS can be transmitted in a subframe allocated for MBSFN transmission. The URS is an RS received by a specific UE or a specific UE group in the cell, and can also be called a demodulation RS (DM-RS). The DM-RS is primarily used in data demodulation of a specific UE or a specific UE group. The PRS may be used for location estimation of the UE. The CSI-RS is used in channel estimation for a PDSCH of an LTE-A UE. The CRI-RS is relatively sparsely arranged in a frequency domain or a time domain. The CSI-RS can be punctured in a data region of a normal subframe or an MBSFN subframe.

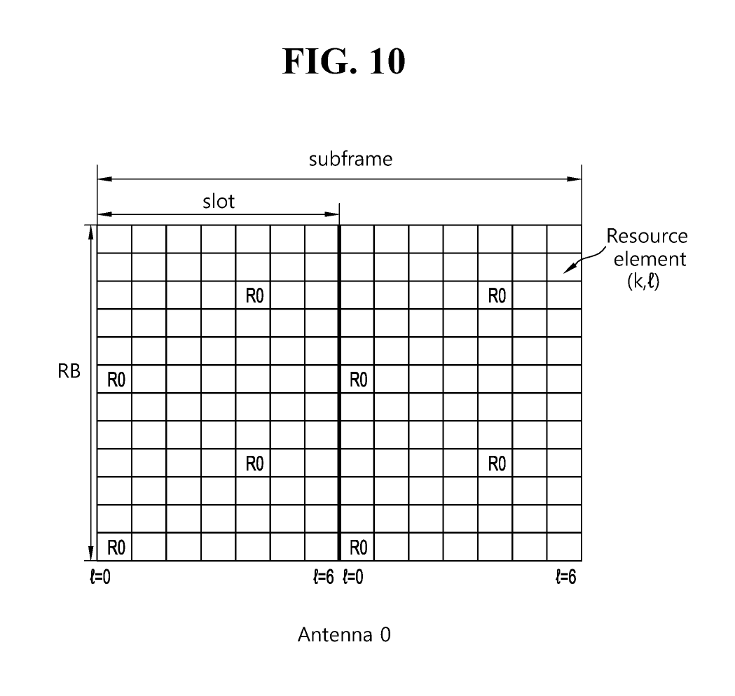

FIG. 10 Shows an Example of a Pattern in which a CRS is Mapped to an RB when a BS Uses One Antenna Port.

Referring to FIG. 10, R0 denotes an RE to which a CRS transmitted using an antenna port number 0 of a BS is mapped.

An RS sequence r_{l,ns(m)} for a CRS is defined as follows.

$${r}_{l , ns} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad [ Equation 1 ]$$

Herein, m=0, 1, . . . , 2N_{maxRB}−1. N_{maxRB} is the maximum number of RBs. ns is a slot number in a radio frame, l is an OFDM symbol index in a slot.

A pseudo-random sequence c(i) is defined by a length-31 gold sequence as follows.

c(n)=(x₁(n+Nc)+x₂(n+Nc))mod 2

x₁(n+31)=(x₁(n+3)+x₁(n))mod 2

x₂(n+31)=(x₂(n+3)+x₂(n+2)+x₂(n+1)+x₂(n))mod 2 [Equation 2]

Herein, Nc=1600, and a first m-sequence is initialized as x₁(0)=1, x₁(n)=0, m=1, 2, . . . , 30. A second m-sequence is initialized as cᵢₙᵢₜ=2¹⁰(7(ns+1)+l+1)(2N^{cell}_{ID}+1)+2N^{cell}_{ID}+N^{CP} at a start of each OFDM symbol. N^{cell}_{ID} is a physical cell identifier (PCI). N_{CP}=1 in a normal CP case, and N_{CP}=0 in an extended CP case.

The CRS is transmitted in all downlink subframes in a cell supporting PDSCH transmission. The CRS may be transmitted on antenna ports 0 to 3. The CRS may be defined only for Δf=15 kHz.

A pseudo-random sequence R_{l,ns}(m) generated from a seed value based on a cell identity (ID) is subjected to resource mapping to a complex-valued modulation symbol a^{(p)}_{k,l} as shown in Equation 3 below.

a_{k,l}^{(p)}=r_{l,n}_{ₛ}(m′) [Equation 3]

Herein, nₛ denotes a slot number in one radio frame, p denotes an antenna port, and l denotes an OFDM symbol number in a slot. k denotes a subcarrier index. l and k are expressed by the following equation.

$$\begin{matrix}k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} & [ Equation 4 ] \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3 \end{matrix} & [ Equation 5 ]\end{matrix}$$

In the above equation, p denotes an antenna port, and nₛ denotes a slot number 0 or 1.

k has 6 shifted indices according to a cell ID (N^{cell}_{ID}). Accordingly, cells having cell IDs 0, 6, 12, etc., which are a multiple of 6, transmit a CRS in the same subframe position k.

In the above equation, l is determined according to the antenna port p, and a possible value for l is 0, 4, 7, 11. Accordingly, the CRS is transmitted on symbols 0, 4, 7, and 11.

A resource element (RE) allocated to a CRS of one antenna port cannot be used in transmission of another antenna port, and must be set to 0 (zero). Further, in a multicast-broadcast single frequency network (MBSFN) subframe, the CRS is transmitted only in a non-MBSFN region.

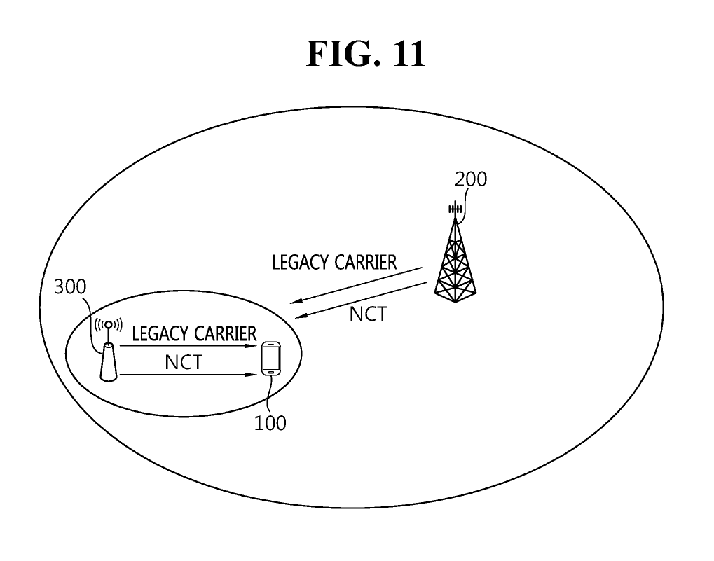

FIG. 11 Shows an Example of a New Carrier for a Next-Generation Wireless Communication System.

The conventional 3GPP LTE/LTE-A-based wireless communication system transmits a reference signal, a synchronization signal, a control channel, etc, through a downlink carrier. As such, the existing downlink carrier based on 3GPP LTE/LTE-A is called a legacy carrier type (LCT). The LCT is also used as an abbreviation of the legacy cell type which implies a cell operating with the existing downlink carrier.

However, a new carrier can be introduced in a next-generation wireless communication system after LTE/LTE-A to mitigate interference between a plurality of serving cells and to improve extensibility of a carrier. This is called an extension carrier or a new carrier type (NCT). The NCT is also used as an abbreviation of the new cell type.

The NCT may be used by a legacy macro cell 200. In addition, the NCT may be located within coverage of the legacy macro cell 200, and may be used by one or more small cells 300 (or also referred to as a pico cell, a femto cell, or a micro cell) having low transmission power.

Although the NCT may be used as a primary cell (i.e., PCell), it is considered that the NCT is mainly used only as a secondary cell (i.e., SCell) together with a legacy-type primary cell (i.e., PCell). If a legacy-type subframe is used in the primary cell (i.e., PCell) and an NCT subframe is used in the secondary cell (i.e., SCell), a configuration for the subframe may be signaled through the secondary cell (i.e., SCell). The secondary cell (i.e., SCell) in which the NCT subframe is used may be activated by the primary cell (i.e., PCell).

When the NCT is used only as the secondary cell as described above, legacy UEs are not considered. Therefore, the legacy UEs do not have to perform cell detection, cell selection, and cell reselection on the secondary cell in which the NCT is used. Alternatively, since the NCT used as only the secondary cell cannot be recognized by the legacy UEs, unnecessary elements can be decreased in comparison to the legacy secondary cell. Therefore, a more effective operation is possible.

Further, in the NCT, transmission of a CRS which is transmitted with a fixed high density is omitted or significantly reduced. In the legacy carrier, the CRS is transmitted in all downlink subframes across a full system band, whereas in the NCT, the CRS may not be transmitted or may be transmitted in a specific downlink subframe throughout a part of the system band. Accordingly, in the NCT, the CRS may not be used in demodulation and may be used only in synchronization tracking. In this sense, the CRS may also be called a tracking RS (TRS) or an enhanced synchronization signal (eSS) or a reduced CRS (RCRS).

The TRS may be transmitted through one RS port. The TRS may be transmitted through the full frequency band or the part of the frequency band.

In the legacy carrier, a PDCCH is demodulated based on the CRS, whereas in the NCT, the PDCCH may not be transmitted. In the NCT, only a DMRS (or URS) is used in data demodulation.

Accordingly, a UE receives downlink data on the basis of the DMRS (or URS), and measures a channel state on the basis of a CRI-RS transmitted relatively less frequently.

When using the NCT, an overhead caused by a reference signal is minimized, and thus reception performance is boosted and a radio resource can be effectively used.

Hereinafter, MTC will be described.

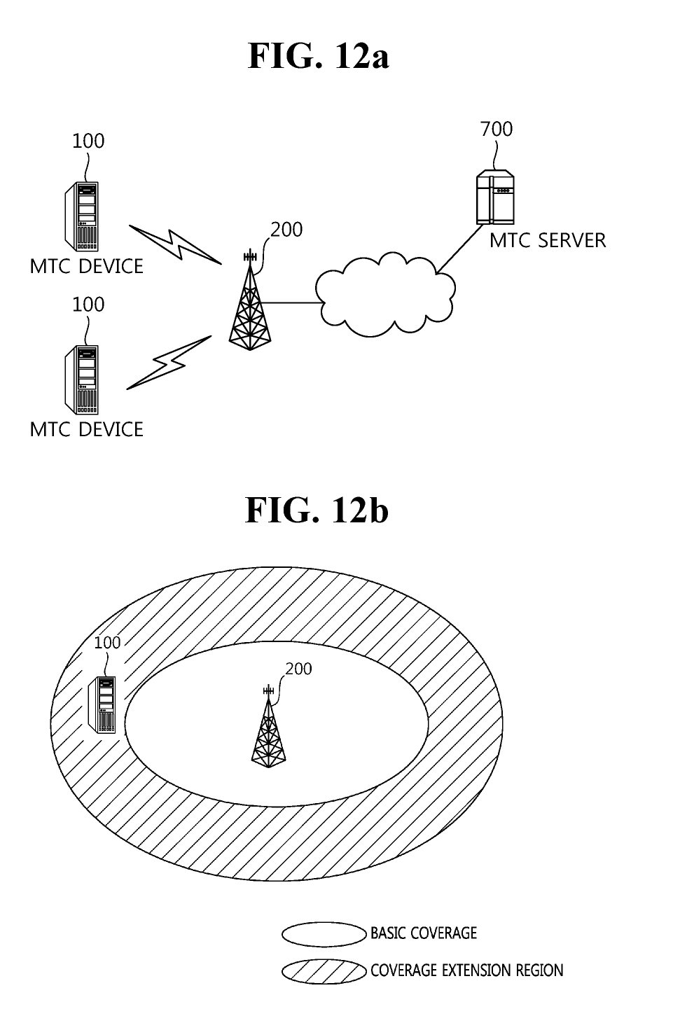

FIG. 12a Illustrates an Example of Machine Type Communication (MTC).

The MTC refers to information exchange performed between MTC devices 100 via a BS 200 without human interactions or information exchange performed between the MTC device 100 and an MTC server 700 via the BS.

The MTC server 700 is an entity for communicating with the MTC device 100. The MTC server 700 executes an MTC application, and provides an MTC-specific service to the MTC device.

The MTC device 100 is a wireless device for providing the MTC, and may be fixed or mobile.

A service provided using the MTC is differentiated from an existing communication service requiring human intervention, and its service range is various, such as tracking, metering, payment, medical field services, remote controlling, etc. More specifically, examples of the service provided using the MTC may include reading a meter, measuring a water level, utilizing a surveillance camera, inventory reporting of a vending machine, etc.

The MTC device is characterized in that a transmission data amount is small and uplink/downlink data transmission/reception occurs sometimes. Therefore, it is effective to decrease a unit cost of the MTC device and to decrease battery consumption according to a low data transmission rate. The MTC device is characterized of having a small mobility, and thus is characterized in that a channel environment does almost not change.

FIG. 12b Illustrates an Example of Cell Coverage Extension for an MTC Device.

Recently, it is considered to extend cell coverage of a BS for an MTC device 100, and various schemes for extending the cell coverage are under discussion.

Meanwhile, when the MTC device 100 performs an initial access to a specific cell, the MTC device 100 receives master information block (MIB), system information block (SIB) information, and radio resource control (RRC) parameters from the cell.

However, when the cell coverage is extended, if the BS transmits a PDSCH including an SIB and a PDCCH including scheduling information for the PDSCH to the MTC device located in the coverage extension region as if it is transmitted to a normal UE, the MTC device has a difficulty in receiving the SIB.

In order to solve the aforementioned problem, the BS may repetitively transmit the PDSCH and the PDCCH to the MTC device 100 located in the coverage extension region on several subframes (e.g., bundle subframes).

On the other hand, a maximum system bandwidth supported by the normal UE is 20 MHz. However, the MTC device 100 is expected to have low performance to increase a distribution rate with a low cost, and thus the bandwidth of 20 MHz may not be fully supported. For example, in order to decrease a manufacturing unit cost, the MTC device 100 may be manufactured to support only a bandwidth of up to 1.4 MHz, 3 MHz, or 5 MHz.

However, when the bandwidth is reduced as described above, the MTC device 100 may not smoothly operate when using only a method of a legacy LTE_A system. Therefore, a method of reducing a downlink bandwidth may consider options described below.

Option 1: A bandwidth is reduced for both of an RF and a baseband.

Option 2: A bandwidth of a baseband is reduced for both of a data channel and a control channel.

Option 3: Only a bandwidth of a baseband for a data channel is reduced, and a bandwidth of a baseband for a control channel is maintained.

A method of reducing an uplink bandwidth may consider operations as follows.

Option 1: A bandwidth is reduced for both of an RF and a baseband.

Option 2: A bandwidth is not reduced.

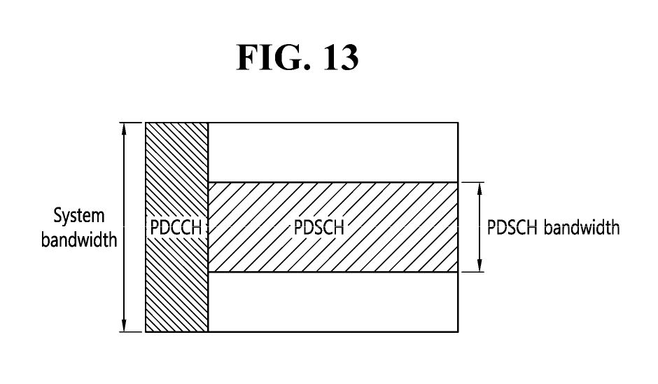

Among the aforementioned options, the option 2 or the option 3 may be preferably used for a downlink in order to decrease a manufacturing unit cost of the MTC device 100. The option 3 is described below with reference to FIG. 13.

FIG. 13 Shows an Example in which a Bandwidth of a Data Channel is Reduced.

As shown in FIG. 13, a downlink control channel (i.e., PDCCH) may be transmitted through an entire system bandwidth to achieve a low-cost MTC device, whereas a bandwidth of a data channel (i.e., PDSCH) may be reduced to a smaller value than the system bandwidth. For example, although a downlink system bandwidth of a corresponding cell is 10 MHz, a bandwidth at which an MTC device 100 operates for data reception may be 1.4 MHz.

Meanwhile, as an effort to decrease a manufacturing unit cost, in order to simplify complexity of an operation, the MTC device 100 may be allowed to support only a transmission mode (TM) based on a CRS. That is, the MTC device 100 may not be able to support a TM9. In this case, there may be a problem in that an MTC device not supporting the TM9 cannot co-exist with a legacy UE supporting the TM9. Accordingly, the present specification proposes methods of solving such problems.

Alternatively, as described above, a next-generation system after LTE-A considers to employ an NCT. However, the MTC device 100 may necessarily support the TM9 or the TM10 to acquire better performance under the NCT. Accordingly, the present specification proposes methods allowing the MTC device 100 to smoothly support the TM9.

Hereinafter, although the proposed methods are described by using the MTC device 100 as a target, the core concept of the present specification may also be applied not only to the MTC device 100 but also to other UEs.

<Disclosures of the Present Specification>

(A) TM9 or TM10 and PRG (Precoding Resource Block Group)

First, when a normal UE operates in a TM9/TM10, the UE must assume a physical resource block (PRB) bundling size, i.e., a precoding resource block group (PRG) size, as shown in the following table according to a system bandwidth. However, in case of an MTC device 100 for receiving a data channel at a reduced bandwidth in comparison to the system band, one disclosure of the present specification proposes that the MTC device 100 should assume a PRG size different from the conventional method.

Specifically, one disclosure of the present specification proposes that the MTC device 100 for receiving a data channel at a reduced bandwidth in comparison to the system bandwidth should determine the PRG size according to a bandwidth of the data channel received by the MTC device 100, instead of determining the PRG size according to the system bandwidth of a cell. That is, the MTC device 100 may interpret and use the system bandwidth shown in the following table as an alternative of the bandwidth of the data channel. Alternatively, the PRG size may always be assumed as 1 by the MTC device 100 for receiving the data channel at the reduced bandwidth in comparison to the system bandwidth. The bandwidth of the data channel is reduced in comparison to the system band, and thus is highly likely to be less than or equal to 6 RBs. Therefore, in case of the MTC device 100, the PRB size may always be assumed as 1 irrespective of the system bandwidth.

Further, since the MTC device 100 has a low mobility, that is, a characteristic of not moving frequently, there is a high probability of being in an environment where a channel state is not changed rapidly in a frequency/time domain. Therefore, when the TM9/TM10 is applied to the MTC device 100, it may be more effective to apply one identical precoding matrix, instead of applying a different precoding matrix for each PRB for transmitting a PDSCH. Therefore, in one disclosure of the present specification, the MTC device 100 performs reception under the assumption that the same precoding matrix is used as to all PRBs for transmitting the PDSCH.

TABLE 4

| System bandwidth (N_{RB}^{DL}) | PRG size (P’) (PRBs) |
|---|---|
| ≦10 | 1 |
| 11-26 | 2 |
| 27-63 | 3 |
| 64-110 | 2 |

Meanwhile, in general, for a channel quality indicator (CQI) report, a size of subband to be measured may be determined according to a downlink system bandwidth. The subband may be a set of k contiguous PRBs. Herein, k is a function of a system bandwidth. The number of subbands for the system bandwidth N_{RB}^{DL} may be given as N=┌N_{RB}^{DL}/k┐.

The supported subband size k is given in the following table.

TABLE 5

| System bandwidth | Subband size (k) |
|---|---|
| 6-7 | undefined |
| 8-10 | 4 |
| 11-26 | 4 |
| 27-63 | 6 |
| 64-110 | 8 |

However, for the MTC device 100 for receiving the data channel at the reduced bandwidth in comparison to the system band, one disclosure of the present specification proposes that the MTC device 100 should determine a size of subband for a CQI report according to the bandwidth of the data channel, instead of determining it according to the downlink system bandwidth. Specifically, it is proposed that the MTC device 100 should interpret a value N_{RB}^{DL} used to determine the subband size in the above table as a value of the bandwidth of the data channel other than the downlink system bandwidth. Herein, as described above, since the MTC device 100 has a low mobility, that is, a characteristic of not moving frequently, there is a high probability of being in an environment where a channel state is not changed rapidly in a frequency/time domain, one disclosure of the present specification proposes that the MTC device 100 should always assume the subband size as 6 RBs.

On the other hand, in case of a wideband CQI, the MTC device may always perform a wideband CQI feedback on the basis of a bandwidth of its data channel.

(B) CSI-RS for MTC Device Supporting TM9/TM10

When the MTC device 100 for receiving the data channel at the reduced bandwidth in comparison to the system bandwidth operates in the TM9/TM10, even if a CSI-RS is transmitted from a BS through an entire system bandwidth, the MTC device may receive the CSI-RS only within the data channel.

(C) CSI-RS for MTC Device not Supporting TM9/TM10

The MTC device 100 may not be able to support the TM9/TM10, or the support of the TM9/TM10 may not be mandatory. As such, the MTC device 100 not supporting the TM9/TM10 may not have to receive a CSI-RS or may not have capability of receiving the CSI-RS. However, if the MTC device 100 co-exists with other legacy UEs in a cell, the cell transmits the CSI-RS on an entire system bandwidth. In this case, the following method may be used for a smooth operation of the MTC device 100 not supporting the TM9/TM10.

First, the cell may report a CSI-RS configuration used by the cell to the MTC device 100 through an MIB for the MTC device, an SIB for the MTC device, or an RRC signal.

Alternatively, the cell may report information regarding an RE region not used for signal/channel transmission to the MTC device.

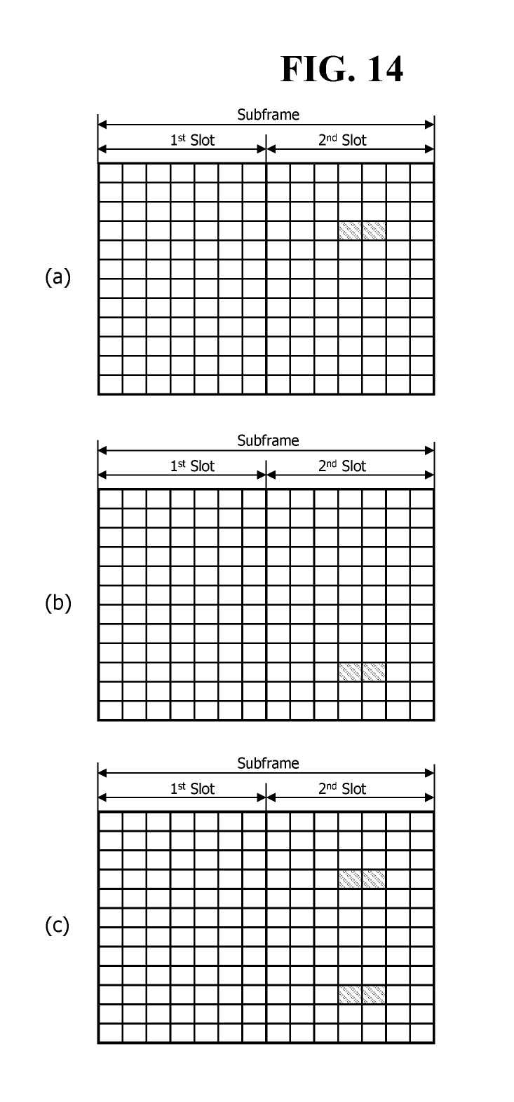

A shadow area shown in FIG. 14 (a) to (c) indicates an unused RE for example. Herein, the unused RE region may be common in the cell, or may be device specific, and such information may be delivered to the MTC device through an SIB or an RRC signal. Information regarding the unused RE region may be expressed for one RB region, and the RE region may be equally applied to all RB regions used by the MTC device. The unused RE region may be delivered to the MTC device in a form of an index selectively indicating one or a plurality of patterns among a plurality of predetermined patterns. When a plurality of indices for the unused RE region are delivered to the MTC device, the MTC device may determine that RE positions corresponding to a total sum of the RE positions are designated as RE regions not used for the MTC device. For example, when values 1 and 5 are received from the cell as index values for the RE regions not used by the MTC device and the index 1 and the index 5 denote RE regions shown in FIG. 14 (a) and FIG. 14 (b), the MTC device may recognize the RE region corresponding to a total sum of the two positions as shown in FIG. 14 (c) as the RE region not used for the MTC device.

As such, if the RE region not used for the MTC device 100 is present, when the cell transmits data for the MTC device 100, the data may be transmitted by performing rate matching or puncturing on the data for the RE region.

(D) Distribution of Operating Time Between MTC Device and Legacy Normal UE

When the legacy normal UE operates together with the MTC device 100 in the same cell, a bundling transmission scheme or the like may be used for coverage extension of the MTC device 100, and thus the MTC device 100 may use most of resources, causing an adverse effect on the legacy normal UE. In order to avoid this, it may be considered that the MTC device 100 operates only in a specific time region.

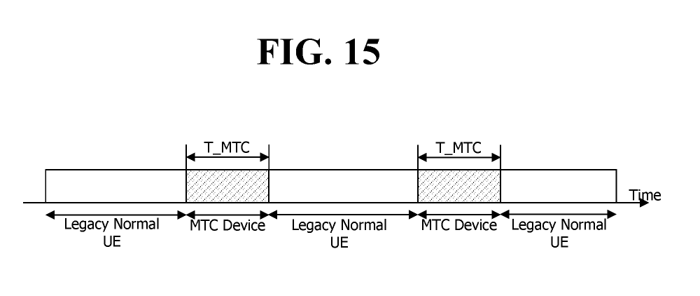

As shown in FIG. 15, a time duration in which the MTC device 100 operates is denoted by T_MTC.

In the T_MTC duration, the legacy normal UE may not operate, and only the MTC device 100 may transmit/receive data.

In this case, in the T_MTC duration, the legacy normal UE may assume that a CSI-RS is not transmitted from a corresponding cell. If the MTC device 100 does not support the TM9/10, the MTC device 100 does not have to receive the CSI-RS. Therefore, in this case, the cell does not have to transmit the CSI-RS during a time when only the MTC device 100 operates. Accordingly, the MTC device 100 may assume that the CSI-RS is not always transmitted in this duration.

Further, in the T_MTC duration, the legacy normal UE may assume that a size of a system bandwidth is always 6 RBs. Alternatively, in the T_MTC duration, the legacy normal UE may assume that the system bandwidth includes a specific number of RBs (in this case, the specific number of RBs is less than or equal to the number of RBs of a real system bandwidth of the cell) determined by the cell. When the bandwidth capable of transmitting the data channel of the MTC device 100 is reduced in comparison to the system bandwidth, the cell does not have to operate always at an entire system bandwidth during a time when only the MTC device 100 operates. Therefore, the cell may operate at a smaller bandwidth than the real system bandwidth in the T_MTC duration in which only the MTC device 100 operates.

Further, in the T_MTC duration, the legacy normal UE may assume that a PDCCH is not transmitted from the cell and only an EPDCCH is transmitted. When the MTC device 100 supports the EPDCCH, if the EPDCCH is used without having to use the PDCCH, there is an advantage in that the MTC device 100 can operate at the smaller bandwidth than the system bandwidth in all OFDM symbol regions in a subframe.

Further, in the T_MTC duration, the legacy normal UE may assume that a common search space (CSS) region is not transmitted through a PDCCH/EPDCCH region. A cell-common resource such as SIB or the like may be transmitted to the MTC device 100 through a predetermined resource without an additional CSS. Therefore, it may be assumed that the CSS does not exist in the PDCCH/EPDCCH in the T_MTC duration in which only the MTC device 100 can transmit/receive data.

(E) Operation of MTC Device in NCT

As described above, in an NCT, a CRS is transmitted rarely or not transmitted at all, and instead, a TRS may be transmitted. As such, since the CRS is transmitted rarely or not transmitted in the NCT, a UE cannot use a TM1 and TM2 operating based on the CRS. Therefore, it is considered that only a TM9 and TM10 operating based on a DMRS are supported in the NCT.

Therefore, when the MTC device operates in the NCT, the MTC device may not support the TM1 and the TM2. When the MTC device operates in the NCT, the following methods may be used for the operation of the MTC device. Herein, the following methods may be used under the assumption that the MTC device can receive information regarding whether its serving cell operates in the NCT or LCT and only when the MTC device determines that the MTC device operates in the NCT.

First, according to one exemplary method, a corresponding cell may transmit a specific DMRS for the MTC device in the NCT. RE position and signaling information of the DMRS may be shared in advance with the MTC device. When the DMRS is called a default DMRS, the default DMRS may be transmitted only on a time and/or frequency resource for transmitting a data/control channel for the MTC device.

A precoding matrix applied when the default DMRS is transmitted may be predetermined so as to be known both to the cell and the MTC device. Alternatively, information regarding the precoding matrix applied when the default DMRS is transmitted may be included in an MIB received by the MTC device. The precoding matrix may be equally applied for transmission of a PDSCH for the MTC device.

Accordingly, the MTC device may use the default DMRS to receive the control/data channel on the NCT, and information regarding the precoding matrix applied to the default DMRS may be received from the cell or may be known in advance. In this case, the MTC device may use the default DMRS for time/frequency tracking, instead of receiving the TRS for the time/frequency tracking.

In addition, the TRS may be punctured in a time and/or frequency resource for transmitting a data channel/control channel for the MTC device. Herein, another channel/signal may be transmitted at a position at which the TRS is punctured.

According to another exemplary method, a corresponding cell may transmit a CSI-RS of a specific configuration for the MTC device in the NCT. Information regarding an RE position of the CSI-RS (i.e., CSI-RS configuration) may be shared in advance with the MTC device. Alternatively, the information regarding the RE position of the CSI-RS (CSI-RS configuration) may be included in the MIB received by the MTC device. When the CSI-RS is called the default CSI-RS, the default CSI-RS may be transmitted only on the time and/or frequency resource for transmitting the data/control channel for the MTC device. In this case, the MTC device may use the default CSI-RS to measure CSI for a specific cell operating in the NCT or to perform RRM (e.g., RSRP/RSRQ measurement).

According to another exemplary method, an antenna port for transmitting a DMRS for the MTC device in the NCT and an antenna ports for transmitting CSI-RS have a quasi co-located (QC) relation.

Meanwhile, the MTC device may not support the operation in the NCT. That is, the MTC device may not be able to perform data transmission/reception in the NCT. When the MTC device not supporting the operation in the NCT needs to receive a service from an NCT cell, even if a corresponding cell is the NCT cell, the MTC device may assume that the cell is an LCT cell. For example, in order for the MTC device to receive the service in the NCT cell, the NCT cell may take an action for LCT in a time/frequency resource region for supporting the MTC device.

The aforementioned embodiments of the present invention can be implemented through various means. For example, the embodiments of the present invention can be implemented in hardware, firmware, software, combination of them, etc. Details thereof will be described with reference to the drawing.

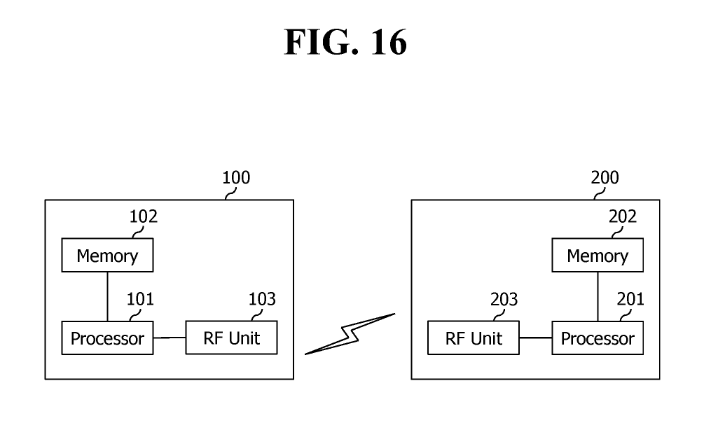

FIG. 16 is a Block Diagram Illustrating a Wireless Communication System According to One Disclosure of the Present Specification.

A BS 200 includes a processor 201, a memory 202, and a radio frequency (RF) unit 203. The memory 202 is coupled to the processor 201, and stores a variety of information for driving the processor 201. The RF unit 203 is coupled to the processor 201, and transmits and/or receives a radio signal. The processor 201 implements the proposed functions, procedures, and/or methods. In the aforementioned embodiment, an operation of the BS may be implemented by the processor 201.

An MTC device includes a processor 101, a memory 102, and an RF unit 103. The memory 102 is coupled to the processor 101, and stores a variety of information for driving the processor 101. The RF unit 103 is coupled to the processor 101, and transmits and/or receives a radio signal. The processor 101 implements the proposed functions, procedures, and/or methods.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. An operational method in a machine type communication (MTC) device, comprising:
if a bandwidth of a data channel has a reduced size in comparison to a system bandwidth of a cell, determining a size of a precoding resource block group (PRG) on the basis of the reduced bandwidth size of the data channel, instead of the size of the system bandwidth; and
if the bandwidth of the data channel has the reduced size in comparison to the system bandwidth of the cell, determining a size of a subband for a channel quality indicator (CQI) feedback on the basis of the reduced bandwidth size of the data channel, instead of the size of the system bandwidth.

2. The operational method of claim 1, wherein the size of the PRG is determined to 1, irrespective of the size of the system bandwidth.

3. The operational method of claim 1, wherein all physical resource blocks (PRBs) in which the data channel is received are applied with the same precoding matrix.

4. The operational method of claim 1, wherein the size of the subband is determined to 6 resource blocks (RBs), irrespective of the size of the system bandwidth.

5. The operational method of claim 1, further comprising feeding back the CQI for the subband having the determined size.

6. The operational method of claim 1, further comprising feeding back a CQI measurement result regarding an entirety of the reduced bandwidth of the data channel as a wideband CQI.

7. A machine type communication (MTC) device comprising:
a transceiver; and
a processor for controlling the transceiver, and if a bandwidth of a data channel has a reduced size in comparison to a system bandwidth of a cell, determining a size of a precoding resource block group (PRG) on the basis of the reduced bandwidth size of the data channel, instead of the size of the system bandwidth,
wherein if the bandwidth of a data channel has the reduced size in comparison to the system bandwidth of the cell, the processor determines a size of a subband for a channel quality indicator (CQI) feedback on the basis of the reduced bandwidth size of the data channel, instead of the size of the system bandwidth.

8. The MTC device of claim 7, wherein the size of the PRG is determined to 1, irrespective of the size of the system bandwidth.

9. The MTC device of claim 7, wherein all physical resource blocks (PRBs) in which the data channel is received are applied with the same precoding matrix.

10. The MTC device of claim 7, wherein the size of the subband is determined to 6 resource blocks (RBs), irrespective of the size of the system bandwidth.

11. The MTC device of claim 7, wherein the processor feeds back the CQI for the subband having the determined size.

12. The MTC device of claim 7, wherein the processor feeds back a CQI measurement result regarding an entirety of the reduced bandwidth of the data channel as a wideband CQI.
